(19) United States
(12) Patent Application Publication
(10) Pub. No.: US 2024/0400258 A1
(43) Pub. Date: Dec. 5, 2024

(54) Modular Food Storage Container

(71) Applicant: Geoffery Armstrong, Macomb, IL (US)

(72) Inventor: Geoffery Armstrong, Macomb, IL (US)

(21) Appl. No.: 18/677,078

(22) Filed: May 29, 2024

Related U.S. Application Data
(60) Provisional application No. 63/469,875, filed on May 31, 2023.

(51) Int. Cl. B65D 21/02; B65D 81/34

(52) U.S. Cl. CPC B65D 21/0208; B65D 81/3453

(57) ABSTRACT

A modular food storage container with a separable compartment that allows stored food items to be prepared independently prior to consumption. The modular food storage container includes a receptacle having a base, perimeter walls, an upper lip, and a pair of compartments separated by a dividing wall. A portion of the upper lip extends outwardly from one side of the receptacle, defining an open frame portion. A removable entrée container includes a base, a perimeter wall, and an upper perimeter flange. The upper perimeter flange of the removable entrée container is configured to removably secure to the open frame portion via a snap-fit connection with the upper lip of the receptacle. The modular food storage container includes individual lids that secure overtop the receptacle and the entrée container separately, or may include a single lid that may secure overtop both containers.

### CROSS-REFERENCE TO RELATED APPLICATIONS

This is a U.S. Non-Provisional patent application that claims the benefit of U.S. Provisional Patent Application No. 63/469,875 filed May 31, 2023. The above identified patent application is herein incorporated by reference in its entirety to provide continuity of disclosure.

### BACKGROUND OF THE INVENTION

Many types of containers exist for storing foods. One subset of such containers includes containers that are designed to store previously prepared food for subsequent consumption. For example, individuals may choose to prepare their meals in advance to save time and to restrict themselves to specific amounts and types of food. These containers are typically made of materials that are safe for use in a microwave and/or oven, and typically include a sealing lid.

Additionally, many individuals consume separate foods for a single meal. To facilitate this separation, some containers may have dividers for separating different food items within the container. While this allows the food items to be separated, a drawback exists where an individual has different types of foods that need to be prepared in different ways. For example, an individual may wish to store a cold food item in one compartment and a food item that needs to be reheated prior to consumption in another compartment. The individual must remove the cold food item from the container before reheating the hot food item. As another example, some food items that need to be reheated will take different lengths of time to reach the ideal temperature, depending on the type of food, size of the portion, and starting temperature. While heating one food item, another may be overcooked, which is undesirable.

In order to address these concerns, the present invention includes a modular food storage container having a removable compartment that may be easily separated from the primary container, microwaved or otherwise prepared on its own, and then reattached to the primary container so that all of the stored food is easily accessible and preparable as needed.

In light of the food storage containers disclosed in the known art, it is submitted that the present invention substantially diverges in design elements from the known art and consequently it is clear that there is a need in the art for an improvement to existing food storage containers.

In this regard the present invention substantially fulfills these needs by providing a modular food storage container with a separable compartment that allows stored food items to be prepared independently prior to consumption.

### SUMMARY OF THE INVENTION

In view of the foregoing disadvantages inherent in the known types of food storage containers now present in the prior art, the present invention provides a modular food storage container wherein the same can be utilitzed for providing convenience for the user when utilizing a modular food storage container.

The invention itself and manner in which it may be made and used may be better understood after a review of the following description, taken in connection with the accompanying figures.

A modular food storage container, comprising a receptacle having a base, a plurality of perimeter walls, an upper lip, a pair of compartments separated by a dividing wall, and a recessed upper sidewall portion to fit a plurality of different types of lids and a lid disposed over the receptacle.

It is an object of the present invention to provide a modular food storage container that includes a detachable entrée section that allows for both hot and cold foods in a single container.

It is an object of the present invention to provide a modular food storage container that combines containers to reduce overall storage and refrigerator clutter.

It is an object of the present invention to provide a modular food storage container that includes less containers, less time, less cooking, less prepping, and less cleaning each week.

### BRIEF DESCRIPTION OF DRAWINGS

Although the characteristics features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the modular food storage container.

FIG. 2 shows an expanded perspective view of an embodiment of the modular food storage container.

FIG. 3 shows a perspective view of an embodiment of the modular food storage container in use.

FIG. 4 shows a perspective view of an embodiment of the modular food container of one of the lids configured to cover all portions of the receptacle and entrée container.

FIG. 5 shows a perspective view of a lower portion of the modular food storage container detailing the connection between the lid and the modular food storage container.

FIG. 6 shows a perspective view of a pop-up lid of the modular food storage container.

### DETAILED DESCRIPTION OF THE INVENTION

Reference is made herein to the attached drawings. Like reference numerals are used throughout the drawings to depict like or similar elements of the modular food storage container. The figures are intended for representative purposes only and should not be considered to be limiting in any respect.

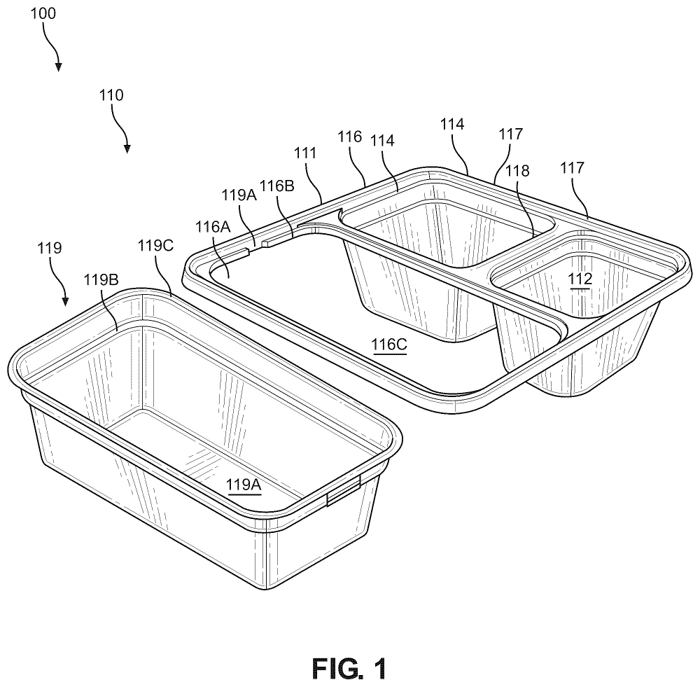

Referring now to FIG. 1, there is shown a perspective view of an embodiment of the modular food storage container 100.

The modular food storage container 100 may include a receptacle 110.

The receptacle 110 may include a base 112, a plurality of perimeter walls 114, an upper lip 116, and a pair of compartments 117 separated by a dividing wall 118. The receptacle 110 may include a recessed upper sidewall portion 111 to fit a plurality of different types of lids 120. A portion of the upper lip 116 may extend outwardly from one side of the receptacle 110, defining an open frame portion 116A. The open frame's perimeter edge 116B may include a lower projection 116C that helps to grasp a removable entrée container 119. The removable entrée container 119 may include a base 119A, a perimeter wall 119B, and an upper perimeter flange 119C. The upper perimeter flange 119C of the removable entrée container 119 may be configured to removably secure to the open frame portion 116A via a snap-fit connection 119D with the upper lip of the receptacle 110.

In the shown embodiment, the perimeter edge 116B of the open portion of the receptacle 110 may include a cut-out or a slot 116C that receives a corresponding tab 119A on the edge of the entrée container 119, to provide an improved and secure connection between the entrée container 119 and the open frame portion 116A of the receptacle 110. Other embodiments may include different or additional securement tabs or fasteners (not shown) to removably secure the entrée container 119 within the open frame portion 116A of the receptacle 110. The receptacle 110 and the entrée container 119 may be made from plastic, aluminum, silicon, glass, or any other food safe material.

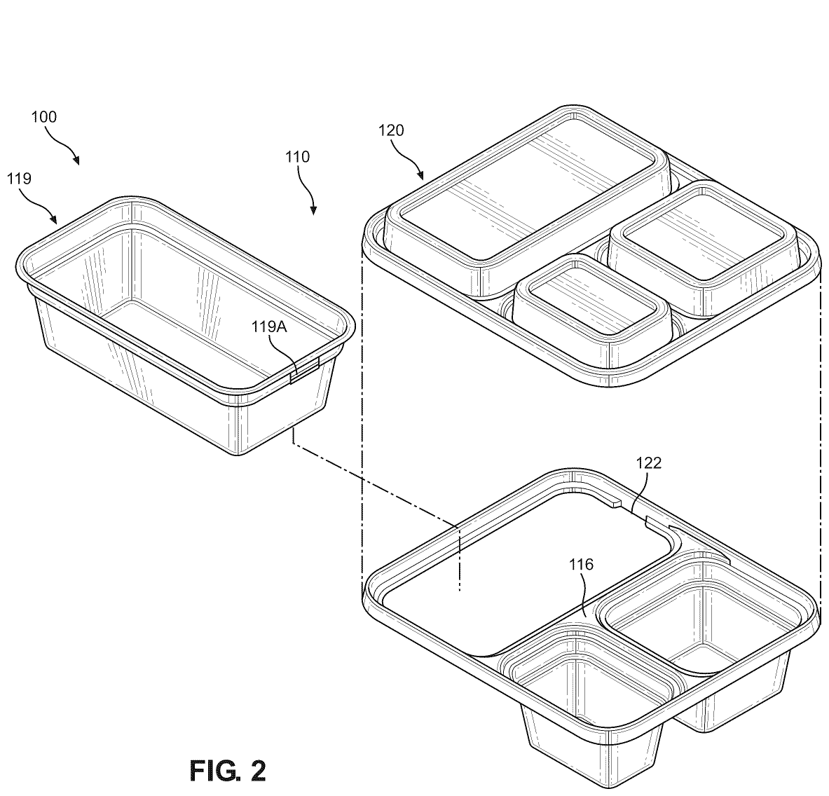

Referring now to FIG. 2, there is shown an expanded perspective view of an embodiment of the modular food storage container 100.

The modular food storage container 100 may include a lid 120.

The lid 120 may be disposed over the receptacle 110.

In this embodiment, a flexible locking tab 122 may be disposed on one end of the open frame portion 116, which engages the corresponding tab 119A of the entrée container 119 for removable securement. When the entrée container 119 may be secured in the receptacle 110, the upper edges of the entrée container 119 may be continuous with the upper edges of the receptacle 110, to maintain the appearance of a modular food storage container 100.

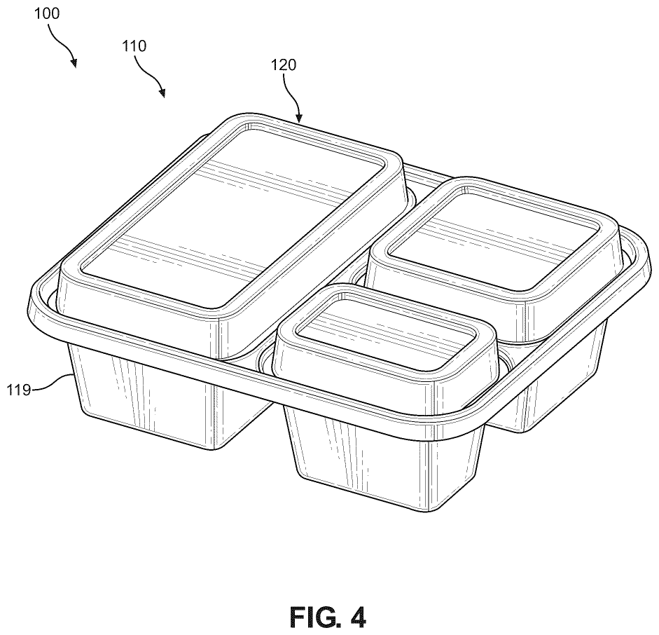

As shown in FIG. 4, one of the lids 120 may be configured to cover all portions of the primary and entrée container 119.

In other embodiments, there may be one of the lids 120 for the entrée container 119 and the receptacle 110 if desired. In the shown embodiment, each of the lids 120 includes slots that receive the modular food storage container 100. This allows one of the lids 120 to seal off the individual compartments to prevent leaks and to prevent one food item in one compartment from entering the compartment that is holding another food item. While the shown embodiment includes one of the lids 120 that removably secures via friction, other types of one of the lids 120 or fasteners may be utilized for additional securement.

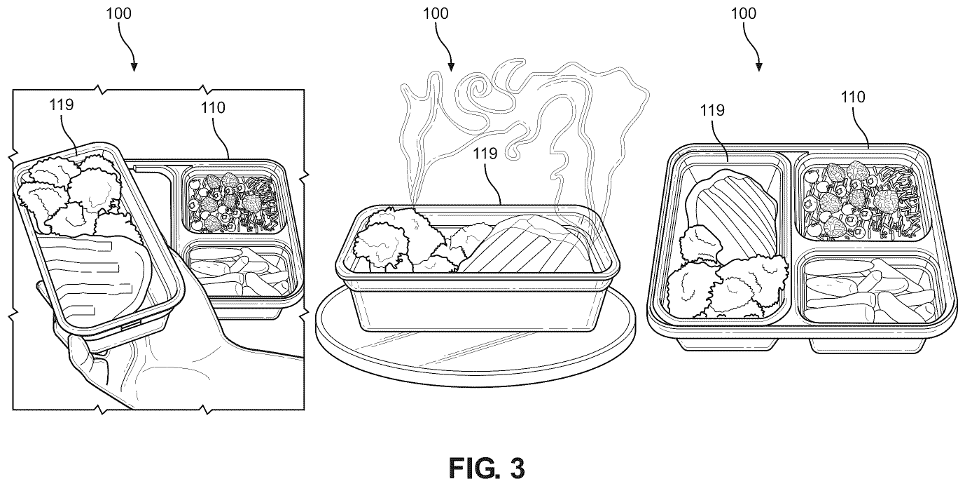

Referring now to FIG. 3, there is shown a perspective view of an embodiment of the modular food storage container 100 in use.

In use, the entrée container 119 may be easily separated from the receptacle 110. Either the modular food storage container 100 may then be microwaved or otherwise prepared on its own. After all food items are prepared as needed, the entrée container 119 may be reattached to the receptacle 110 so that all of the stored food is easily accessible. In this way, the same modular food storage container 100 may be used to store foods that are meant to be heated and foods that are meant to remain unheated. The modular food storage container 100 may also provide a convenient means for supporting the food for consumption, as the food is already separated and does not have to be placed on another surface for serving.

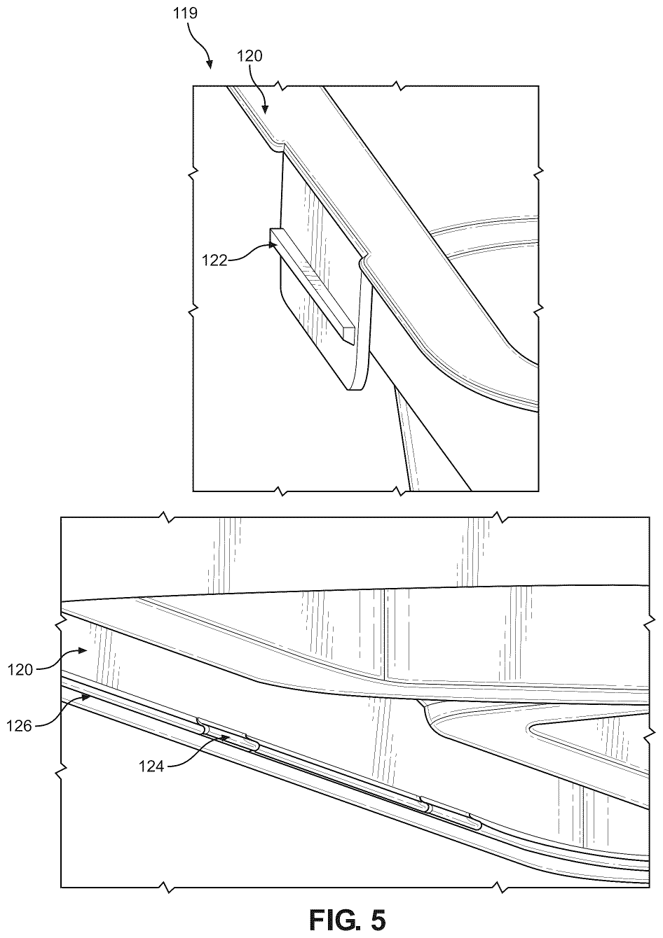

Referring now to FIG. 5, there is shown a perspective view of a lower portion of the modular food storage container 100 detailing the connection between one of the lids 120 and the modular food storage container 100. In the shown embodiment, the entrée container 119 may include a plurality of snap tabs 124 that removably lock into place within the open portion of the modular food storage container 100. The snap tabs 124 may be pressed-in with a finger to release the entrée container 119 from the modular food storage container 100. The lid 120 may provide a secure connection that will resist spills. It may be liquid tight in some embodiments and not liquid tight in other embodiments. The lid 120 also includes a snap ring 126 as well as several snap tabs 122 that removably secure the lid 120 to the receptacle 110.

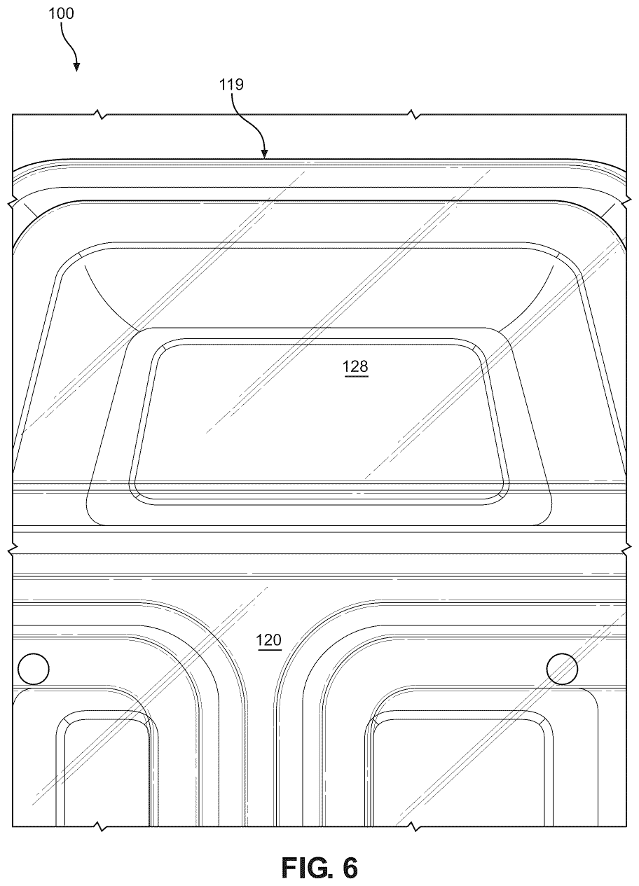

FIG. 6 shows a perspective view of a pop-up lid 126 of the modular food storage container 100.

The pop-up lid 126 may be disposed over the entrée container 119. The pop-up lid 126 may be depressed to release and open upwards and may make a clicking sound when released. The pop-up lid 126 may be separate from the lid 120.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A modular food storage container, comprising:
a receptacle having a base, a plurality of perimeter walls, an upper lip, a pair of compartments separated by a dividing wall, and a recessed upper sidewall portion to fit a plurality of different types of lids;
a removable entrée container having a base, a perimeter wall, and an upper perimeter flange;
wherein the upper perimeter flange of the removable entrée container is removably secured to an open frame portion with the upper lip of the receptacle;
wherein the removable entrée container is removably secured to an open frame portion with the upper lip of the receptacle via a snap-fit connection; and
a lid disposed over the receptacle.

2. The modular food storage container, according to claim 1, wherein the receptacle includes a recessed upper sidewall portion to fit a plurality of different types of a plurality of the lids.

3. The modular food storage container, according to claim 2, further comprising a portion of the upper lip extending outwardly from one side of the receptacle, defining an open frame portion.

4. The modular food storage container, according to claim 3, wherein the perimeter edge of an open portion of the receptacle includes a cut-out or a slot that receives a corresponding tab on the edge of the entrée container to provide an improved and secure connection between the entrée container and the open frame portion of the receptacle.

5. The modular food storage container, according to claim 1, wherein an open frame perimeter edge includes a lower projection that helps to grasp the removable entrée container.

6. The modular food storage container, according to claim 1, wherein the removable entrée container is made of material selected from the group consisting of plastic, aluminum, silicon, glass, or any other food safe material.

7. The modular food storage container, according to claim 1, further comprising a flexible locking tab disposed on one end of the open frame portion, which engages a corresponding tab of the entrée container for removable securement.

8. The modular food storage container, according to claim 1, wherein the removable entrée container is secured in the receptacle, a plurality of upper edges of the removable entrée container is continuous with the upper edges of the receptacle.

9. The modular food storage container, according to claim 1, wherein the lid is configured to cover all portions of the entrée container and the receptacle.

10. The modular food storage container, according to claim 1, wherein the lid includes a plurality of slots that receive the modular food storage container.

11. The modular food storage container, according to claim 10, wherein the lid seals off the individual compartments to prevent leaks and to prevent one food item in one compartment from entering the compartment that is holding another food item.

12. The modular food storage container, according to claim 1, wherein the entrée container is easily separated from the receptacle.

13. The modular food storage container, according to claim 1, wherein the entrée container is microwavable.

14. The modular food storage container, according to claim 1, wherein the receptacle is microwavable.

15. The modular food storage container, according to claim 1, wherein the modular food storage container allows for supporting food contained in the modular food storage container for consumption, as food is already separated and does not have to be placed on another surface for serving.

16. The modular food storage container, according to claim 1, wherein the removable entrée container includes a plurality of snap tabs that removably lock into place within an open portion of the modular food storage container.

17. The modular food storage container, according to claim 16, wherein the plurality of snap tabs are pressed-in to release the entrée container from the modular food storage container.

18. The modular food storage container, according to claim 16, wherein the lid includes the plurality of snap tabs that removably secure the lid to the receptacle.

19. The modular food storage container, according to claim 1, wherein the lid includes a snap ring that removably secures the lid to the receptacle.

20. The modular food storage container, according to claim 1, further comprising a pop-up lid disposed over the entrée container that makes a clicking sound when released.
